(19) United States
(12) Patent Application Publication
(10) Pub. No.: US 2020/0086823 A1
(43) Pub. Date: Mar. 19, 2020

(54) Car-Transportable Cradle for Injured Animals

(71) Applicant: Rosemary Christine Koop, Oregon City, OR (US)

(72) Inventor: Rosemary Christine Koop, Oregon City, OR (US)

(21) Appl. No.: 16/694,639

(22) Filed: Nov. 25, 2019

Related U.S. Application Data
(63) Continuation-in-part of application No. 15/617,964, filed on Jun. 8, 2017, now Pat. No. 10,486,641.
(60) Provisional application No. 62/347,362, filed on Jun. 8, 2016.

(51) Int. Cl. B60R 22/10; A01K 1/02; A01K 15/04; A01K 27/00; A01K 1/00; A01K 1/06

(52) U.S. Cl. CPC B60R 22/10; A01K 1/0272; A01K 1/0613; A01K 27/002; A01K 1/0035; A01K 15/04

(57) ABSTRACT

A car-transportable cradle for injured animals used to hold a pet in place while riding in a car. The apparatus includes a resting panel, a first wing, a second wing, a first handle, a second handle, a first harness-attachment point, a second harness-attachment point, a standing base, and a car-seat securing mechanism. The resting panel retains an injured animal in a semi-recumbent position. The first wing and the second wing enclose the sides of the resting panel preventing the injured animal from being displaced from the proper securing position. The first handle and the second handle provide the user with gripping surfaces to easily transport the present invention into and out or a passenger car. The standing base retains the present invention securely on top of the car-seat. The car-seat securing mechanism prevents the present invention ensure the present invention remains mounted when the car accelerates or changes direction.

The current application is a continuation-in-part (CIP) application of a U.S. non-provisional application Ser. No. 15/617,964 filed on Jun. 8, 2017. The U.S. non-provisional application Ser. No. 15/617,964 claims a priority to the U.S. Provisional Patent application Ser. No. 62/347,362 filed on Jun. 8, 2016.

### FIELD OF THE INVENTION

The present invention generally relates to a car-transportable cradle for injured animals. In particular, a car-transportable cradle for injured animals with a car-seat securing mechanism capable of arresting forward and backward momentum of the car-transportable cradle created under instances of acceleration and deceleration is disclosed.

### BACKGROUND OF THE INVENTION

In the field of animal welfare, it is often the case that when an animal is injured, sick, or in general discomfort, the animal can get agitated. An injured animal is aggravated very easily and oftentimes become very aggressive towards anyone who tries to get near it, such as caretakers or medical personnel. Further, the animal can also start struggling and moving around in a violent manner to try to get away from its caretaker or owner. This can result in the animal exacerbating its injuries and prevents successful treatment of the animal. This kind of situation is especially difficult for pet owners who do not have the means to treat their pet by themselves. The pet owners have to try to calm the aggravated and aggressive pet enough so that it can be transported to a medical treatment for successful treatment of its injury.

Recent AAA surveys have shown that 64 percent of pet owners partake in unsafe distracted driving habits with their pets in the car. An additional 29 percent of the respondents admitted to being distracted while driving with their pets, and another 84 percent indicated that they do not secure their pet in their car. Oftentimes, the pet or animal is cause of distraction for the driver which can cause unsafe driving and accidents. This creates an especially dangerous situation as during a 35-mile-per-hour crash, an unrestrained 60-pound animal would exert the force of a 2700-pound load. Unrestrained animals can impede rescue workers in more serious accidents and are more likely to get hurt themselves or even be thrown out of the vehicle.

The objective of the present invention is to provide a car-transportable cradle for carrying sick and/or injured animals to and from a veterinary facility. It is yet another objective of the present invention to provide a means to securely retain the animal in the cradle which it is being transported, to ensure that the animal does not hurt itself or the veterinary workers. It is yet another objective of the present invention to provide a way to fasten the car-transportable cradle to the seat of the car in a highly secure manner, that can withstand the forces generated when the car accelerates and brakes.

The present invention is a car-transportable cradle for transporting injured or sick animals inside a passenger car. The present invention is designed to transport recently injured, sickly, or unconscious animals, in this case pet animals, in a safe manner to and from urgent care, clinics, home, etc. A novel car-seat securing mechanism keeps the present invention stable when the car carrying the present invention accelerates, turns, or brakes. Further, several supplemental seat fasteners are provided to fasten the present invention to various anchoring points that can be found in and around conventional car seats.

The present invention is molded out of 100% non-porous medical grade plastic. The use of high-grade materials allows the present invention to go through a thorough sterilization and disinfection process. The disinfection and sterilization process removes contaminants such as contagious viruses borne out of the bodily fluids of the animal being transported. Once disinfected, the present invention can be reused for an indefinite amount of time. This presents a clear improvement in the field of car-transportable animal carriers available in the public domain.

The present invention is designed as a durable medical equipment for professional facilities, hospitals, and clinics, which is made available to the clients of said organizations, to ensure their animals are transported in a safe and comfortable manner. The present invention may also be used by pet owners or breeders who have desire for a safe way to transport dogs in case of an emergency. The present invention may also be sold through commercial outlets or rented for a single use scenario.

### BRIEF DESCRIPTION OF THE DRAWINGS

FIG. 1 is a front perspective view of the present invention.

FIG. 2 is a rear perspective view of the present invention.

FIG. 3 shows a detail perspective view of the bracing portion and the second harness attachment point.

FIG. 4 shows a detail perspective view of the bracing portion and the car-seat securing mechanism.

FIG. 5 is a detail perspective view of the present invention showing the third harness-attachment point.

FIG. 6 is detail bottom perspective view showing the first supplemental seat fastener.

FIG. 7 shows a detail front perspective view showing the animal harness attached to the first harness-attachment point and the second harness-attachment point.

FIG. 8 is a front perspective view of the present invention, wherein the present invention has been expanded.

FIG. 9 is a bottom perspective view of the present invention, wherein the lid has been removed from the storage compartment.

FIG. 10 is a front perspective view of the expended configuration of the present invention, wherein the assembly has been exploded to illustrate construction.

FIG. 11 is a bottom plan view of the present invention, wherein the first base fastener and the second base fastener have been disengaged.

### DETAILED DESCRIPTION OF THE INVENTION

All illustrations of the drawings are for the purpose of describing selected versions of the present invention and are not intended to limit the scope of the present invention.

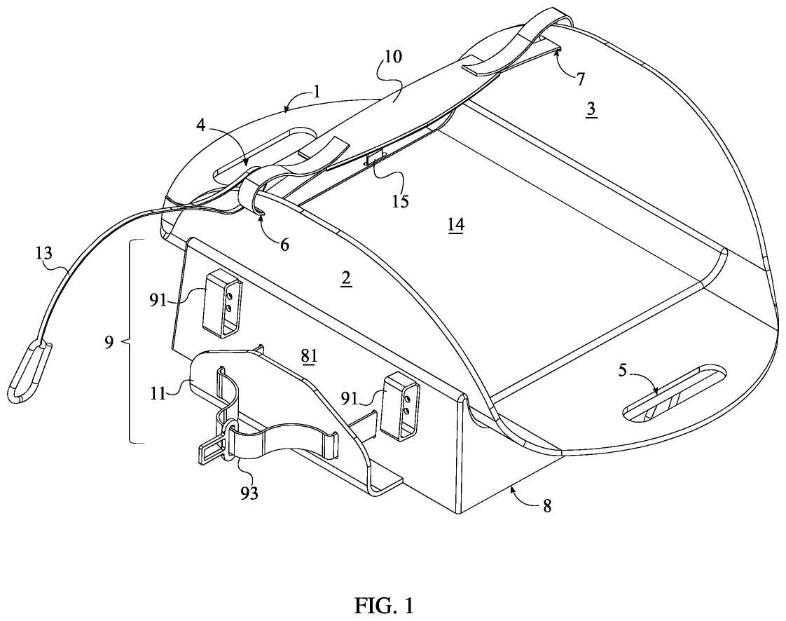

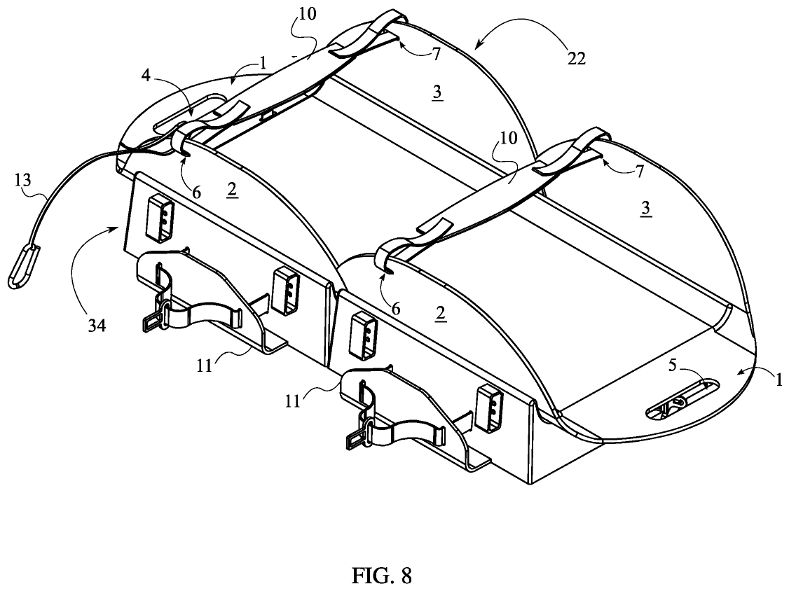

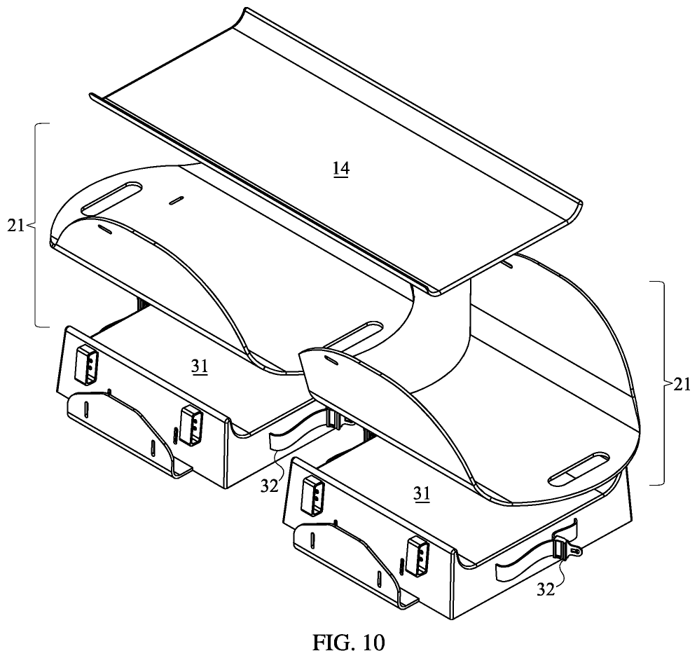

As illustrated in FIG. 1 through 7, the present invention is a transportable cradle suited to transport animals by adapting a conventional car seat to provide a stable platform for said animal. The present invention provides a configurable series of fastening features suitable for fixation to any type of seat or interior structure of a car, van, or automobile in general. The transportable cradle further provides for the interchange and replacement of expendable layers and materials, enabling a user to quickly recondition the present invention should an animal soil or otherwise dirty the present invention. As further illustrated in FIG. 8 through 11, the present invention may comprise a modular construction of multiple repeated instances of the transportable cradle to provide an expanded capacity for larger animals, or multiple smaller animals simultaneously. The expanded modular configuration of the present invention is further equipped with alternate embodiments of components of the standalone iteration suitable for the elongated structure said components may be equipped to. Additionally, it is contemplated that the modular structures may interlink to form a contiguous structure or may be independently connected to a seat or vehicle in a linear pattern. Though the structures and assemblies described herein are primarily suitable for use within automobiles, it is fully appreciated that a user may find application for the present invention in residential or veterinary settings. Additionally, the transportable cradle may be employed outside of medical emergencies to routinely transport a pet without risking damage to a vehicle interior, as may be caused by an animal resting directly on a seat cushion or vehicle carpet.

In reference to FIG. 8 through 11, the expanded configuration of the present invention comprises a plurality of length-adjustable litters 21, a plurality of standing bases 8, and a plurality of car-seat securing mechanisms 9. Each of the standing bases 8 further comprises a base body 31, a first base fastener 32, and a second base fastener 33. Each of the length-adjustable litters 21 is mounted to a corresponding base 34 from the plurality of standing bases 8, providing a contiguous bed for an animal to lay across. The length-adjustable litters 21 define a series of modular components that may be arranged across the plurality of standing bases 8 to form a supportive brace for an animal, while simultaneously providing multiple elevated hardpoints to which said animal may be restrained. In various embodiments contemplated, the length-adjustable litters 21 may further comprise any suitable means of fastening the repeated instances of said component into a functional arrangement. Broad consideration is given to the fastening hardware employed to this end, understood to comprise any type of interlocking fastener without express limitation. This arrangement will permit the use of the transportable cradle is situations wherein a singular instance of the present invention may be unsuitable to transport an animal or animals, or in instances wherein a sufficiently large embodiment of the singular instance may protrude laterally to an unsuitable degree to fit within the cabin of a vehicle. The first base fastener 32 is laterally mounted to the base body 31, the second base fastener 33 being laterally mounted to said base body 31 opposite to the first fastener. The first base fastener 32 and the second base fastener 33 provide a means of fixing an arbitrary standing base 8 to an adjacent instance of the standing base 8, thereby providing an elongated substructure across which multiple instances defined within the plurality of length-adjustable litters 21 may be positioned. In at least one alternate embodiment, this physical connection may be achieved or supported by external support structures, bars, braces, or other reinforcing members as may be appropriate for any given installation. The car-seat securing mechanism 9 is laterally mounted to the base body 31, positioned between the first base fastener 32 and the second base fastener 33. The car-seat securing mechanism 9 enables the arbitrary standing base 8 to fix to a car seat, specifically to any associated buckles or clasps as may be regularly found in a vehicle comprising a conventional safety restraint. In the modular configuration, the first base fastener 32 of the arbitrary base is attached to the second base fastener 33 of the adjacent base, wherein the arbitrary base and the adjacent base may both be defined within the plurality of standing bases 8. More specifically, the first base fastener 32 and the second base fastener 33 ideally define compound mechanical fasteners of any description, specifically that each instance of the first fastener or the second fastener comprises the male-end and female-end of a compatible releasable linkage. This arrangement enables the arbitrary standing base 8 to be linked to the adjacent instance of the standing base 8 regardless of the orientation of the arbitrary standing base 8 relative to the adjacent instance of the standing base 8.

Referring now to FIGS. 1 and 8, the preferred embodiment of the present invention comprises the plurality of length-adjustable litters 21, each further comprising a resting panel 1, a first wing 2, a second wing 3, a first handle 4, a second handle 5, at least one first harness-attachment point 6, at least one second harness-attachment point 7, a standing base 8, and a car-seat securing mechanism 9. The resting panel 1 allows the animal to rest in a semi-reclined position with its legs folded below its body. This is the natural resting position for most quadrupedal animals, so the animal can remain seated for prolonged periods of time without feeling irritated or uncomfortable, as may be required during long journeys. The resting panel 1 is connected onto the base body 31. The base body 31 suspends the resting panel 1 over the car seat, preventing the resting panel 1 from sinking into the seat cushion. This also prevents the resting panel 1 from leaning sideways, which can displace the animal from the proper position. In the preferred embodiment of the present invention, the resting panel 1 may be adhered, fastened, or integrated into the standing base 8 during the fabrication process. Alternately, the resting panel 1 may be removably coupled to the standing base 8 with snap locks, magnets, or screws. The use of hundred-percent non-porous medical grade plastic enables the present invention to be disinfected and reused, however, any such rigid, lightweight, and/or chemically non-reactive material can be utilized. It is additionally contemplated that the use of conventional materials as may be readily available to the public in general in the manufacture of the present invention will not depart from the spirit or scope of the claimed matter as described. The resting panel 1 can be adjustably sized during the fabrication process to provide sufficient space for large or small animals.

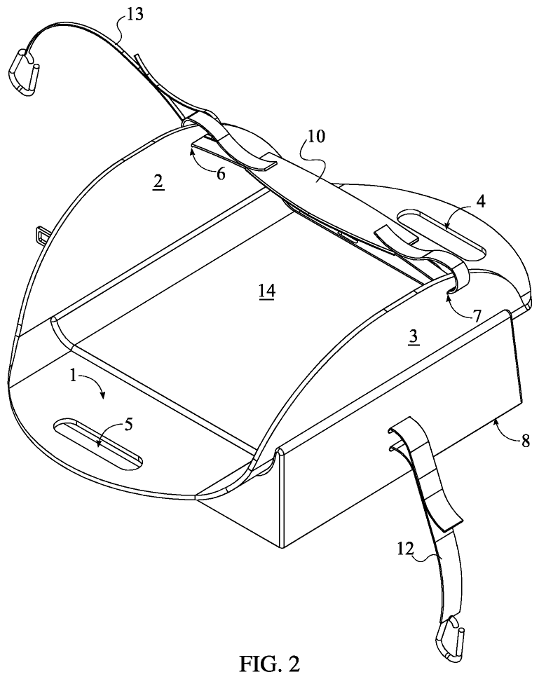

As can be seen in FIG. 2, the car-seat securing mechanism 9 is laterally mounted to the standing base 8. The car-seat securing mechanism 9 secures the resting panel 1 and the standing base 8 to the car seat. The first wing 2 is connected adjacent to the resting panel 1. The second wing 3 is connected adjacent to the resting panel 1 opposite the first wing 2. The first wing 2 and the second wing 3 form protective barriers that retain the animal in the center of the resting panel 1. The first handle 4 and the second handle 5 are positioned opposite each other across the resting panel 1. The first handle 4 and the second handle 5 are positioned perpendicular to the first wing 2 and the second wing 3. A user may grip the first handle 4 to transport the present invention when it is not carrying an animal. The user must use both the first handle 4 and the second handle 5 to transport the present invention when it is carrying an animal. The first handle 4 and the second handle 5 are placed symmetrically about the center axis. When the user grips the first handle 4 and the second handle 5 to lift the present invention, the load is distributed evenly about the center axis, which reduces excess stress on the user's wrists. The first harness-attachment point 6 is integrated into the first wing 2. The second harness-attachment point 7 is integrated into the second wing 3. The first harness-attachment point 6 and the second harness-attachment point 7 are preferably fashioned out of elongated slots cut into the first wing 2 and the second wing 3.

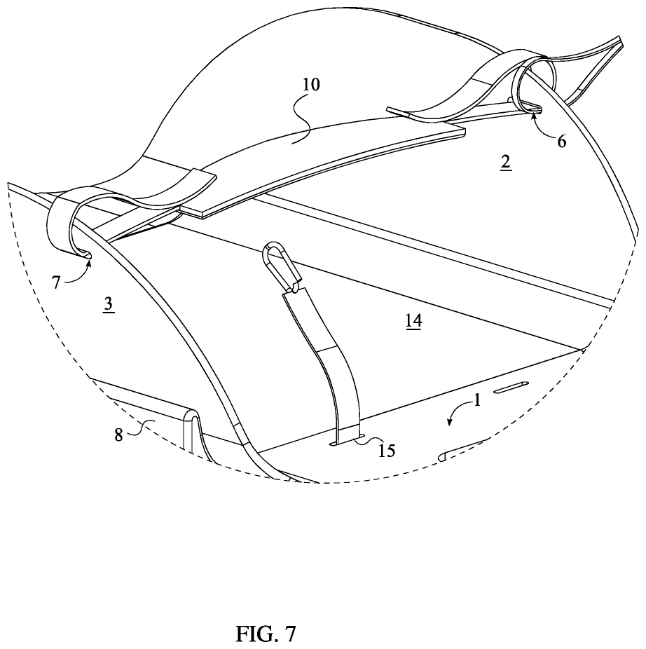

Referring now to FIG. 7, the present invention may comprise an embodiment wherein each of the plurality of length-adjustable litters 21 further comprises an animal harness 10 that is tethered in between the first harness-attachment point 6 and the second harness-attachment point 7. The animal harness 10 secures the top opening of the resting panel 1 and keeps the animal's torso close to the resting panel 1. This increases stability and prevents the animal from fall out of the resting panel 1. The animal harness 10 is preferably composed of a high strength fabric strap with a first adjuster clip and a second adjuster clip. The first end of the animal harness 10 is looped around the first harness-attachment point 6 and inserted into the first adjuster clip. This prevents the first end from slipping out of the first harness-attachment point 6 and preserves the loop in its position. The second end of the animal harness 10 loops around the second harness-attachment point 7 and is secured in position by the second adjuster clip. The portion of the animal harness 10 pressing against the animal's body may be lined with a soft padding or cushioning material to reduce irritation to the animal. In another embodiment, the animal harness 10 may comprise a strap system that wraps around the whole torso of the animal. The first adjuster clip and the second adjuster clip also allow the user to adjust the tightness of the animal harness 10 around the torso of the animal. In another possible embodiment of the present invention, a plurality of animal harnesses 10 is used to restrain a large animal. In this embodiment, a plurality of first harness-attachment points 6 and a plurality of second harness-attachment points 7 are used to secure the plurality of animal harnesses 10 to the resting panel 1. The car-seat securing mechanism 9 may also scales to successfully span the enlarged resting panel 1.

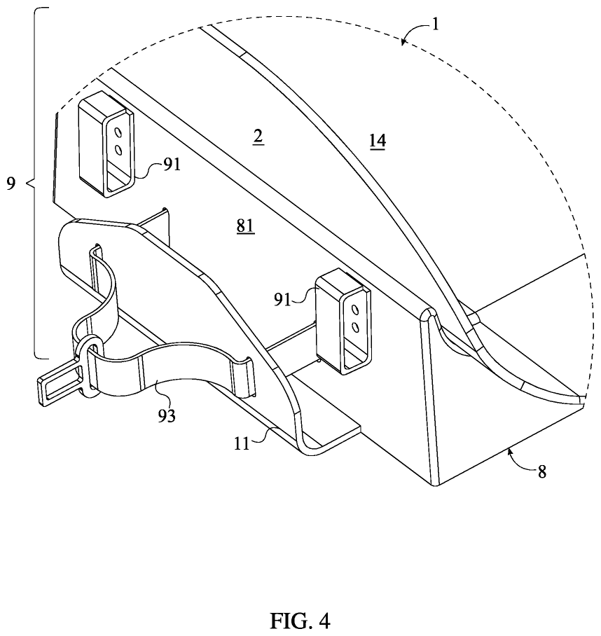

Referring to FIGS. 4 and 8, the present invention further comprises a plurality of offsetting flanges 11. Each of the plurality of offsetting flanges 11 are laterally connected to the corresponding base 34. The offsetting flange 11 offsets the corresponding base 34 away from the back cushion of the car seat. The vertical wall of the offsetting flange 11 provides a physical barrier which prevents the corresponding base 34 from tipping over into the car seat when the car starts accelerating. Additional embodiments of the offsetting flange 11 may define a series of conventional seat-clips and anchors understood to be analogous or identical to conventional safety restraint hardware employed in associated with child seats. The preferred embodiment of the plurality of car-seat securing mechanisms 9 comprises a plurality of belt hooks 91. A bracing portion 81 of the corresponding base 34 is positioned adjacent to the first wing 2. The plurality of belt hooks 91 is connected adjacent to the bracing portion 81. The plurality of belt hooks 91 is also distributed across the bracing portion 81. In the preferred implementation, the bracing portion 81 rests adjacent to the back cushions of a car seat. This allows the seat-belt strap to be inserted through each of the plurality of belt hooks 91. The plurality of belt hooks 91 is meant to be used with conventional sash belt type seatbelts. The plurality of belt hooks 91 is sized to allow a seat-belt tongue to pass easily through each of the plurality of belt hooks 91 and connect to a seat-belt buckle disposed on the opposite side of the car seat. The seat-belt webbing interlocks with the plurality of belt hooks 91 and presents a physical barrier which limits forward movement of the present invention. It is further contemplated that the offsetting flange 11 may comprise a

As can be seen in FIG. 4, in another embodiment of the present invention, each of the car-seat securing mechanisms 9 comprises a seat-belt connector 93. The bracing portion 81 of the standing base 8 is positioned adjacent to the first wing 2. The seat-belt connector 93 is tethered to the bracing portion 81. In this embodiment, the seat-belt connector 93 loops through an elongated slot cut into the offsetting flange 11. The seat-belt connector 93 comprises a seat-belt tongue slid over a strap. The seat-belt tongue may be locked into position along the seat-belt strap under the discretion of the user. The overall length of the seat-belt connector 93 may also be adjusted to the liking of the user. The seat-belt tongue connects to the seat-belt buckle placed on the side of the car seat. Thus, the present invention can be engaged to the car seat by connecting the seat-belt tongue found in the seat-belt connector 93 to the seat-belt buckle on the car seat. The seat-belt buckle is provided with a push button disengagement mechanism allowing the seat-belt tongue to disconnect with the seat-belt buckle.

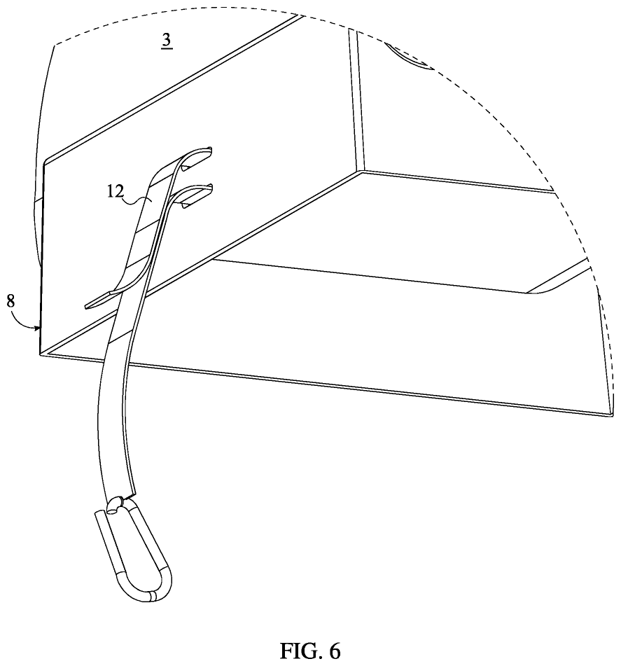

Referring now to FIG. 6, the first supplemental seat fastener 12 is tethered each of the plurality of standing bases 8. The first supplemental seat fastener 12 and the car-seat securing mechanism 9 is positioned opposite to each other about the base body 31. Inertia causes the present invention to move backwards into the seat cushion when the car accelerates forward. The first supplemental seat fastener 12 is attached to the front of the car opposite the bracing portion 81 to arrest the backward momentum of the present invention when the car is accelerating. A latch mounted to the end of the first supplemental seat fastener 12 connects to a front anchoring point located in front of the seat cushion. The front anchoring point may comprise an anchor bar that interlocks with the latch on the first supplemental seat fastener 12. The first end of the latch comprises a hook, and the second end of the latch comprises a swiveling bar. In order to connect the first supplemental seat fastener 12 to the latch, the swiveling bar retracts into the concave side of the hook, which allows the user to insert the anchor bar into the hook. Once the anchor bar is inside the hook, the swiveling bar extracts and closes the hook. The front anchoring point for the first supplemental seat fastener 12 is placed on or near the cabin floor of the car. In alternate embodiments of the present invention, the latch may utilize a variety of detachable coupling mechanisms including, but not limited to, snap locking fasteners, magnetic fasteners, clasps, or like fastening mechanisms that can easily engage with front anchoring point.

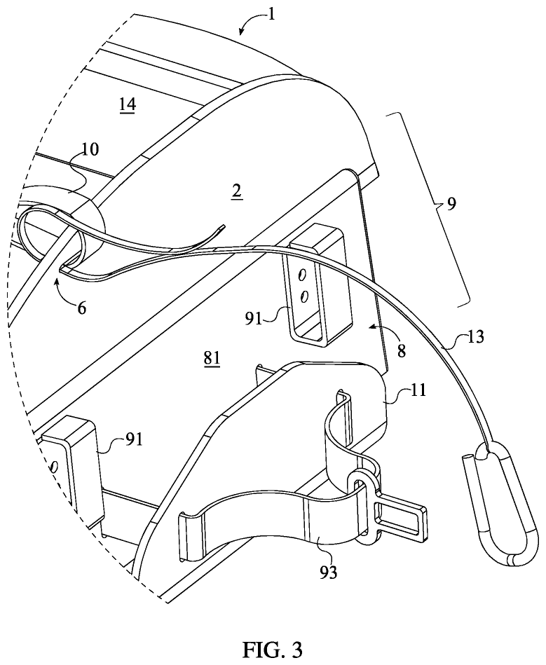

As can be seen in FIG. 3, the second supplemental seat fastener 13 is tethered to the first wing 2 of a corresponding litter 22, wherein the corresponding litter 22 is from the plurality of length-adjustable litters 21. The second supplemental seat fastener 13 is used to connect the present invention to a rear anchoring point located on the back of the car seat. The acceleration of the car causes the present invention to rotate in the clockwise or counterclockwise direction depending on the direction of acceleration. The second supplemental seat fastener 13 mounts on the first wing 2 at a vertical position that arrests this rotational movement. A latch is used to connect the second supplemental seat fastener 13 to the rear anchoring point. The rear anchoring point may be situated anywhere on the rear of the car seat, such as on the bottom of the head rest, the rear surface of the back cushion, or on the floor immediately behind the car seat. The latch selectively couples to the anchoring bar which connects the second supplemental seat fastener 13 to the rear anchoring point.

Referring once again to FIG. 1, a washable veterinary lining 14 is attached onto and across the plurality of length-adjustable litters 21 opposite the plurality of standing bases 8. In the preferred embodiment of the present invention, the washable veterinary lining 14 comprises a soft hydrophilic fabric material placed on top of the resting panel 1. Alternately, the washable veterinary lining 14 may be integrated onto the interior surfaces of the resting panel 1. The washable veterinary lining 14 is placed between the animal and the resting panel 1 to prevent animal's skin from rubbing on the resting panel 1. The hydrophilic material absorbs bodily fluids excreted by the animal, as is common when animals are injured or hurt. Once the animal is successfully transported, the washable veterinary lining 14 is removed and put through a washing process. The washing process utilizes a sterilizing sub-process that neutralizes any harmful contagious viruses or organic matter. The washing process effectively removes all contaminants absorbed in the hydrophilic material, making the washable veterinary lining 14 reusable. In the elongated modular configuration, it is understood that the washable veterinary lining may be of increased lateral dimensions to fit to the combined length of the plurality of length-adjustable litters 21.

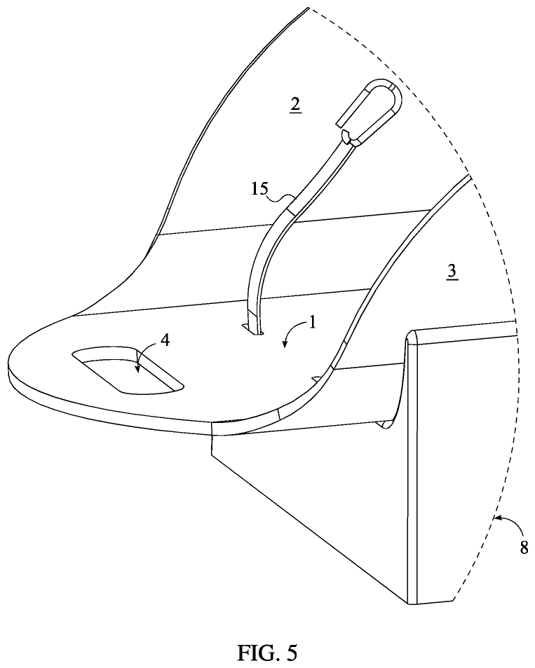

As can be seen in FIG. 5, a third harness-attachment point 15 is integrated into the resting panel 1 of a corresponding litter 22, wherein the corresponding length-adjustable litter is from the plurality of length-adjustable litters 21. The third harness-attachment point 15 is positioned in between the first wing 2 and the second wing 3. The third harness-attachment point 15 comprises a left slot and a right slot. Both the left slot and the right slot can connect to a leash strap that connects to the collar of the animal. The third harness-attachment point 15 is used restrain the animal and keep its body close to the resting panel 1. The user has the option to use either the left strap or the right strap, separately. Both the left strap and the right strap can be used at the same time to restrain a large animal.

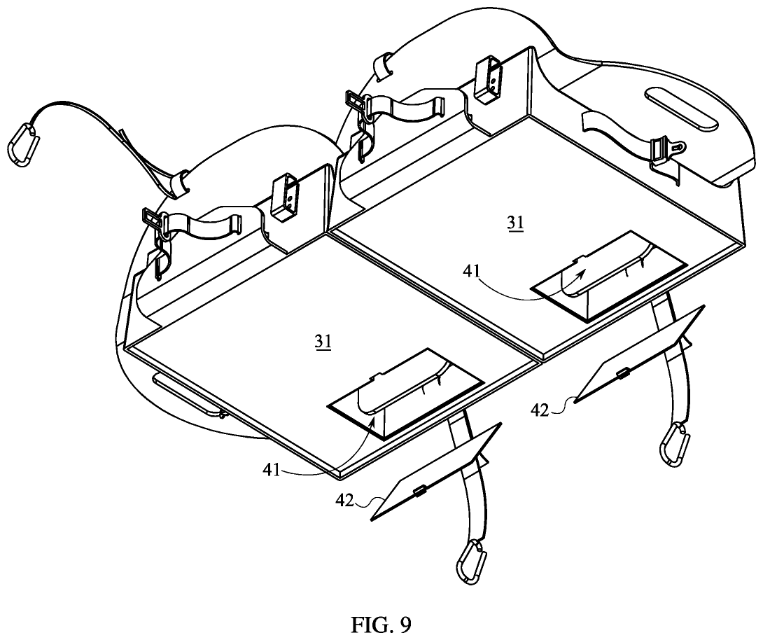

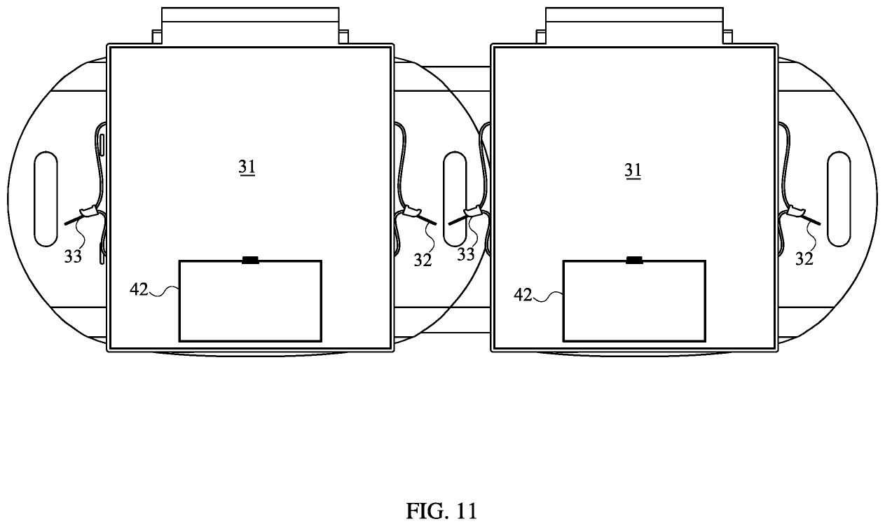

As illustrated in FIGS. 9 and 11, the transport cradle comprises an embodiment wherein each of the standing bases 8 further comprises a storage compartment 41 and a lid 42. The storage compartment 41 normally traverses into the base body 31 at a location offset from the first base fastener 32, the second base fastener 33, and the car-seat securing mechanism 9. The lid 42 is removably mounted over the storage compartment 41, such that the lid 42 is retained in position enclosing the storage compartment 41 until a user manually removes said lid 42. The storage compartment 41 provides an enclosure for a user to store various loose appendages of the transportable cradle for storage or transport. Such appendages may include, for example, the first base fastener 32 or the second base fastener 33 of a terminally positioned instance of the standing base 8, or any spare instances of the animal harness 10 not currently employed to restrain an animal.

Although the invention has been explained in relation to its preferred embodiment, it is to be understood that many other possible modifications and variations can be made without departing from the spirit and scope of the invention as hereinafter claimed.

What is claimed is:

1. A transportable cradle for injured animals comprises:
a plurality of length-adjustable litters;
a plurality of standing bases;
a plurality of car-seat securing mechanism;
each of the plurality of standing bases comprising a base body, a first base fastener and a second base fastener;
each of the plurality of length-adjustable litters being mounted onto a corresponding base from the plurality of standing bases;
the first base fastener being laterally mounted onto the base body;
the second base fastener being laterally mounted onto the base body, opposite to the first base fastener;
the car-seat securing mechanism being laterally mounted onto the base body;
the car-seat securing mechanism being positioned in between the first base fastener and the second base fastener; and
the first base fastener of an arbitrary base being attached to the second base fastener of an adjacent base, wherein the arbitrary base and the adjacent base are from the plurality of standing bases.

2. The transportable cradle for injured animals as claimed in claim 1 comprises:
each of the plurality of length-adjustable litters comprising a resting panel, a first wing, a second wing, a first handle, a second handle, at least one first harness-attachment point, and at least one second harness-attachment point;
the resting panel being connected onto the base body;
the first wing being connected adjacent to the resting panel;
the second wing being connected adjacent to the resting panel, opposite the first wing;
the first handle and the second handle being integrated into the resting panel;
the first handle and the second handle being positioned opposite to each other across the resting panel;
the first handle and the second handle being positioned perpendicular to the first wing and the second wing;
the first harness-attachment point being integrated into the first wing; and
the second harness-attachment point being integrated into the second wing.

3. The transportable cradle for injured animals as claimed in claim 1 comprises:
each of the plurality of standing bases further comprising a first supplemental seat fastener;
the first supplemental fastener being tethered to the base body; and
the first supplemental fastener and the car-seat securing mechanism being positioned opposite to each other about the base body.

4. The transportable cradle for injured animals as claimed in claim 1 comprises:
a washable veterinary lining; and
the washable veterinary lining being attached onto and across the plurality of length-adjustable litters, opposite to the plurality of standing bases.

5. The transportable cradle for injured animals as claimed in claim 1 comprises:
each of the plurality of standing bases further comprising a storage compartment and a lid;
the storage compartment normally traversing into the base body;
the storage compartment being positioned offset from the first base fastener, the second base fastener and the car-seat securing mechanism; and
the lid being mounted over the storage compartment.

6. The transportable cradle for injured animals as claimed in claim 1 comprises:
a plurality of offsetting flanges; and
each of the plurality of offsetting flanges being laterally connected to the corresponding base.

7. The transportable cradle for injured animals as claimed in claim 2 comprises:
each of the plurality of length-adjustable litters further comprising an animal harness; and
the animal harness being tethered in between the first harness-attachment point and the second harness-attachment point.

8. The transportable cradle for injured animals as claimed in claim 2 comprises:
each of the plurality of car-seat securing mechanisms comprises a plurality of belt hooks;
a bracing portion of the standing base being positioned adjacent to the first wing;
the plurality of belt hooks being connected adjacent to the bracing portion; and
the plurality of belt hooks being distributed across the bracing portion.

9. The transportable cradle for injured animals as claimed in claim 2 comprises:
each of the plurality of car-seat securing mechanisms comprises a seat-belt connector;
a bracing portion of the standing base being positioned adjacent to the first wing; and
the seat-belt connector being tethered to the bracing portion.

10. The transportable cradle for injured animals as claimed in claim 2 comprises:
a second supplemental seat fastener; and
the second supplemental fastener being tethered to the first wing of a corresponding litter, wherein the corresponding litter is from the plurality of length-adjustable litters.

11. The transportable cradle for injured animals as claimed in claim 2 comprises:
each of the plurality of length-adjustable litters further comprising a third harness-attachment point;
the third harness-attachment point being integrated into the resting panel; and
the third harness-attachment point being positioned in between the first wing and the second wing.
